(19) United States
(12) Patent Application Publication
(10) Pub. No.: US 2018/0200621 A1
(43) Pub. Date: Jul. 19, 2018

(54) Game Link Method

(71) Applicant: Cornell GOSS, Oakland, CA (US)

(72) Inventor: Cornell GOSS, Oakland, CA (US)

(21) Appl. No.: 15/743,652

(22) PCT Filed: Jul. 11, 2016
(86) PCT No.: PCT/US2016/041814

§ 371 Date: Jan. 10, 2018

Related U.S. Application Data
(60) Provisional application No. 62/191,198, filed on Jul. 10, 2015.

(51) Int. Cl. A63F 13/323; A63F 13/30

(52) U.S. Cl. CPC A63F 13/323; A63F 13/30

(57) ABSTRACT

Disclosed is system for enabling real-time cross-platform game play comprising a virtual machine configured to translate game play data from one or more separate game consoles. A first user uses a first game console, wherein the first game console communicates first game play data to the virtual machine in a first format. A second user uses a second game console, wherein the second game console communicates second game play to the virtual machine in a second format, the virtual machine translating the first game play in the first format into a neutral format. The virtual machine translates the second game play in the second format into the neutral format. An observer receives signals from the virtual machine, wherein the signals comprise the neutral format and wherein the virtual machine synchronizes the first format with the second format for the translated neutral format.

### CROSS-REFERENCE TO RELATED APPLICATION(S)

The present application claims priority to U.S. Provisional Patent Application No. 62/191,198 filed on Jul. 10, 2015, entitled “Game Link Method” the entire disclosure of which is incorporated by reference herein.

### BACKGROUND OF THE INVENTION

### 1. Field of Invention

This invention relates to a system to enable real-time communication and game play on different computers, mobile devices and consoles in the field of gaming.

### 2. Description of Related Art

In the art, computerized game play is mainly executed on consoles, wherein the users play on the console. Each of the major consoles is proprietary and there is no way for gaming between consoles Through gaming networks, it is possible to play games against other participants on difference consoles, but there has been no capability for cross-console gaming, therefore games are more or less proprietary to a single console. Games that exist across consoles are very different between the different console versions, and are incompatible.

Therefore there is a need in the art for a cross-console gaming system wherein the proprietary commands from one console are recognizable to another console, permitting gaming between consoles.

### SUMMARY OF THE INVENTION

In an embodiment, a system for enabling real-time cross-platform game play comprises the steps of a virtual machine configured to translate game play data from one or more separate game consoles; a first user using a first game console, wherein the first game console communicates first game play data to the virtual machine in a first format; a second user using a second game console, wherein the second game console communicates second game play to the virtual machine in a second format, the virtual machine translating the first game play in the first format into a neutral format; the virtual machine translating the second game play in the second format into the neutral format; an observer receiving signals from the virtual machine, wherein the signals comprise the neutral format, wherein the virtual machine synchronizes the first format with the second format for the translated neutral format.

In another embodiment, the virtual machine further comprises a hardware chip to accelerate the translation of game play data to and from the neutral format.

In another embodiment, the virtual machine resynchronizes the data multiple times per second.

In another embodiment, the step of the first user using the first game console further comprises the first user initiating a game within the first game console; and the first console generating the first game play data based on one or more game functions.

In an embodiment, the step of the second user using the second game console further comprises the second user initiating a game within the second game console; and the second console generating the second game play data based on one or more game functions;

In another embodiment, the first user, the second user, and the observer authenticate their use of the first game console, the second game console, and the virtual machine through biometric verification, respectively.

In another embodiment, the process further comprises the steps of storing the resynchronized data on at least one separate server and updating the signals, wherein the signals are received by the user after each time the data is resynchronized.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flow chart diagram showing the functions of the game link, according to an embodiment of the present invention; and

FIG. 2 is a functional diagram showing communication of the game link, according to an embodiment of the present invention.

### DETAILED DESCRIPTION OF PREFERRED EMBODIMENTS

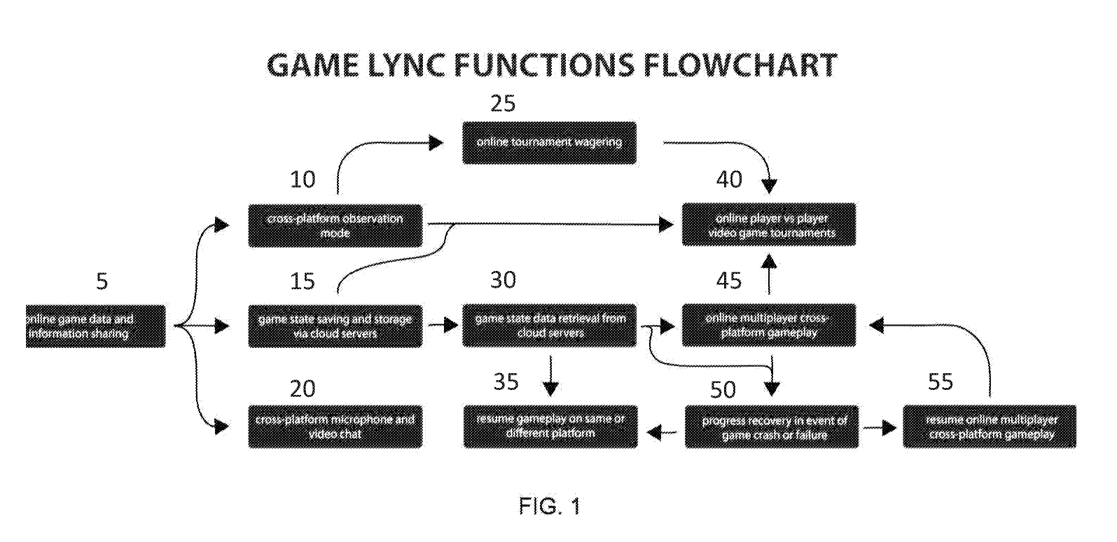

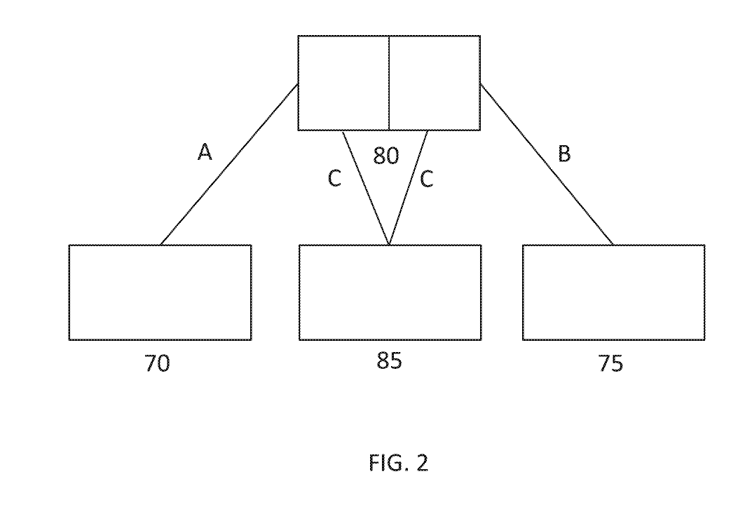

Preferred embodiments of the present invention and their advantages may be understood by referring to FIGS. 1-2 wherein like reference numerals refer to like elements.

With reference to FIG. 1, the function, purpose, and scope of a software application is shown. This application involves video game networking and will provide a service that will allow users to participate in cross-platform online gameplay on current, last, and next-generation consoles as well as mobile and personal computer devices. Moreover, users of an existing online gaming service on one platform (e.g. Xbox Live, Playstation Network) can use the aforementioned application to play with users on another platform, despite the fact that both users regularly use different online gaming platforms. Thus the application functions as a bridge between the two separate platforms using command translation and/or a virtual machine, that is, a third, universal set of commands that each of the console's commands are translated into. The commands are then translated from the virtual machine into the language of the second platform. Any of the features of the system described below may be used separately and independently on related systems to provide those features within an existing online gaming service.

In step 5, the system engages in online game data and information sharing with one or more other systems, which may occur by channels, namely cross-platform observation, game state saving, or cross-platform microphone and video chat. In step 5, the online game data sharing may also involve verification of the users' identity, namely players' and observers' identity through biometrics, for example. In step 10 in cross-platform observation mode, the user's input does not impact the game play information, however the user is able to observe other player's movements and interactions in the game. In step 15, the user is involved and game state is saved and stored in cloud servers. In step 20, cross-platform microphone and video chat is permitted, linked to a particular player or observer. which follows a separate channel. In an embodiment, the observer using cross-platform observation mode in step 10 also has access to the microphone and video chat in step 20. Also, a player may use the game state saving at step 15 and communicate via microphone and video chat. However, an observer in step 10 is marked as such and may not save their state in step 15.

Once in observation mode in step 10, the observer may engage in online tournament wagering at step 25, wherein the observer wagers on a player, and/or the observer may also wager on online player vs player tournaments in step 40. The tournament entry in step 40 and the wagering may require confirmation of the users identity. The game state save channel at step 15 causes retrieval of game state data from the clouds servers, to synchronize the player's game state with those of other players, considering and adjusting for the other players' actions effects on the player's environment. In step 45 the players are engaged in online multiplayer cross-platform gameplay, and in the event of a game crash or failure, at step 35 the game may be resumed from the last save and synchronize point, on the same of different platform, or may, at step 55, resume online multiplayer cross-platform gameplay from the last save and synch points. Throughout the gameplay, the microphone and video chat of step 20 is available to players and observers.

With reference to FIG. 2, a virtual machine 80 is configured to translate game play data from one or more separate game consoles 70 and 75. In an embodiment, a first user is using a first game console 70, wherein the first game console communicates first game play data to the virtual machine in a first format through A. A second user is using a second different and incompatible game console 75, wherein the second game console communicates second game play to the virtual machine in a second format along B. The virtual machine 80 translates the first game play in the first format A into a neutral format, and translates the second game play in the second format B into the neutral format, and a third party observer 85 receives signals from the virtual machine, such that the observer may observe the game play between 70 and 75, wherein the signals comprise the neutral format C, and wherein the virtual machine 80 synchronizes the first format with the second format for the translated neutral format. The data may be partitioned within the virtual machine and kept separate, wherein the two data flows are merged or provided on split screen to the observer.

The application will retrieve and have access to game data that involves multiplayer online gameplay and seamlessly share the information between two devices, just as normal online services do, but without circumventing the need for existing services provided by Microsoft, Sony, or any other platform owner. Information that is shared cross-platform includes but is not limited to, game state, namely the position of the player's avatar, most recent actions, and the state of the player's environment, and the state of other players within the game, microphone input, and speaker and video output; thus gamers will not only be able play with each other, they may also talk with each other via microphones and platform-integrated cameras (e.g. as provided with Microsoft Kinect). The application is optimized to reduce the amount of additional input required from game developers and publishers that will be necessary for the app to function and minimize the delay between multiple players' experiences.

The data on players identities and movements/actions within the game are uploaded to a database in the network cloud wherein they are either i) translated into commands for movements/actions for another console type, or ii) translated into a virtual machine (a common 3^{rd} format for commands) before being translated into commands for movements/actions for another console type. The advantage to direct translation into the commands for another console type is faster processing and transmission time. The advantage to translating into a virtual machine as an intermediary before translation to another console type is storage of the data in the cloud for multi-user play such as tournaments. For games that vary in versions between platforms, the game will be rewritten into a neutral third format (“custom version”) that contains all the actions of the platforms, such that the actions are understood across the platforms. In order to discourage game developers from producing a simple port of their game, it is encouraged that the neutral third party version act as the standard from which the other ports are made.

In order for the system to work, the game must be available on multiple platforms. Each user has a userid to identify himself and his console type to the system so the system knows which proprietary format to send. For each action the players take, the action information is sent to the server and stored, after which it is translated and sent to the competing user's console. Game-specific prediction algorithms operate to smooth the synching and anticipate actions on the part of the players, such that communication of all the action data is not a prerequisite to the action taking place on the competing player's screen. The key difference is that the data that is sent from client to server and vice versa is stored in an abstract, proprietary format that can be relatively quickly translated, client side, into the game's or platform's data formats. Other data such as hardware integrated camera video or microphone audio input will be transferred in a similar manner but to a lesser extent as this data, more or less, already exist in more universal formats.

Licensing may be required to developers of games and console hardware, and the system may operate on a per-subscription or per-download basis. Users of the application will pay a recurring subscription fee to access games to download and access the multi-platform features of the system. The system may eliminate the need to download the entire game, permitting a streaming format wherein only the parts of the game that are required for immediate gameplay are downloaded.

The application has other features, one of which (cross-saving) allows users to optionally have their online game state saved and backed up to a server as they play, over short time intervals, which will allow them to restore their game state in the event of a game failure that causes users to lose their progress. Therefore this feature potentially can allow users to completely avoid unintentionally losing game progress during online play for certain games. The game state is saved on the servers in neutral format, and the data can be provided to the original console or another console type in the event of a loss of data on the console. The progressive save function will allow games that are being played to be saved in the cloud as they progress, multiple times per second. In the event of a crash, the system will automatically recognize where the crash occurred and allow the gamer to pick up where they left off.

Other features could include a cross-platform observation mode which will allow players to view their friends' screens as they play and another game state save feature that will allow players to play a game on one platform and later on, continue their progress on another platform, or similar device on the same platform, via cloud storage. Third parties who are not playing are also able to stream the contents of players' screens. Multiple views may be watched simultaneously such that a multi-player tournament may be scored. In an embodiment, observation mode is a live feed of any game being played by one gamer that can be streamed live to any device with a screen, computer smart tv or console as long as the observer has the system installed and is on the player's “friends” list.

Another feature is tournament mode that will allow users to set up and host tournaments in specific games, cross-platform, in a reliable, robust, and efficient manner. The tournament mode will also allow those involved to participate in online match wagering. More specifically, the application will use its other, previously mentioned features including the server save feature (internal saving of the games) to ensure that no progress is lost throughout the tournament and allow multiple users to observe the tournament contestants or the tournament in its entirety in a structured manner making such events more accessible to those who only wish to watch instead of participate. The interval saving feature stores the games in the neutral format, to enable the game to be easily resumed from any console type.

The game play may integrate match wagering features that can be automated and regulated by the server to ensure there are no fraudulent transactions made among users (and that there is no cheating during the matches that are being wagered), as well as biometric identification of the wagerer. Individuals may host tournaments by inviting one or more players to the tournament. Other tournaments may be hosted by corporations or by the system itself. Wagering may be between players and/or audience observers. While some tournaments may be free, others may require an admission fee. Further, tournaments may have pre-requisites for entry, such as attainment of certain minimum scores or levels by the player.

In an embodiment, the system verifies input from a biometrics identification mechanism within the user's game controller, to verify the user's identity against a stored verified identifier, to ensure that the player who is entered into, and playing at, the tournament is the same player that was invited, to prevent the use of “ringers”, and to prevent the player from betting against himself to “throw” the game.

Users have a friend list on the system, which provides information on the UserIDs of “friends” and other players to the user, such that the user may seamlessly play the same game with another on a different console. The game object code may reside partially in the cloud to facilitate network play, wherein the local console only downloads the modules and gameplay components required for the current user's progress. In an embodiment, since the game and the actions of the other players are contained in the cloud, the actions and gameplay may be combined such that other players' actions are registered on the user's console in real time. The cloud may also contain the saved games of the users, wherein the user may resume the saved game on another platform.

All of these features will be incorporated into the application and will result in a massive online gaming hub that will ultimately allow users to seamlessly interact with other users and carry game progress between different platforms.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims

I claim:

1. A system for enabling real-time cross-platform game play comprising the steps of:
a. a virtual machine configured to translate game play data from one or more separate game consoles;
b. a first user using a first game console, wherein the first game console communicates first game play data to the virtual machine in a first format;
c. a second user using a second game console, wherein the second game console communicates second game play to the virtual machine in a second format;
d. the virtual machine translating the first game play in the first format into a neutral format;
e. the virtual machine translating the second game play in the second format into the neutral format; and
f. an observer receiving signals from the virtual machine, wherein the signals comprise the neutral format,
wherein the virtual machine synchronizes the first format with the second format for the translated neutral format.

2. The system of claim 1, wherein the virtual machine further comprises a hardware chip to accelerate the translation of game play data to and from the neutral format.

3. The method of claim 1, wherein the virtual machine resynchronizes the data multiple times per second.

4. The system of claim 1, wherein the step of the first user using the first game console further comprises:
i. the first user initiating a game within the first game console; and
ii. the first console generating the first game play data based on one or more game functions.

5. The system of claim 1, wherein the step of the second user using the second game console further comprises:
i. the second user initiating a game within the second game console; and
ii. the second console generating the second game play data based on one or more game functions.

6. The system of claim 2, wherein the first user, the second user, and the observer authenticate their use of the first game console, the second game console, and the virtual machine through biometric verification, respectively.

7. The method of claim 3, further comprising the steps of:
a. storing the resynchronized data on at least one separate server; and
b. updating the signals, wherein the signals are received by the user after each time the data is resynchronized.
